(19) United States
(12) Patent Application Publication
(10) Pub. No.: US 2008/0126212 A1
(43) Pub. Date: May 29, 2008

(54) Method of Marketing Credit Card Accounts and Point-Of-Sale Payment Devices

(76) Inventor: Mark A. Cox, West Chester, PA (US)

Correspondence Address: FOX ROTHSCHILD, LLP, 625 LIBERTY AVENUE, PITTSBURGH, PA, 15222-3155, US

(21) Appl. No.: 11/943,576

(22) Filed: Nov. 20, 2007

Related U.S. Application Data
(63) Continuation-in-part of application No. 11/456,906, filed on Jul. 12, 2006.
(60) Provisional application No. 60/866,909, filed on Nov. 22, 2006.
(60) Provisional application No. 60/866,922, filed on Nov. 22, 2006.
(60) Provisional application No. 60/942,729, filed on Jun. 8, 2007.

(51) Int. Cl. G06Q 40/00; G06Q 20/00

(52) U.S. Cl. 705/17; 705/38

(57) ABSTRACT

A method for issuing a permanent credit device to a user at a point of sale involves the use of a credit device for performing point of sale transactions which is able to be programmed on the fly with new or existing credit account information for one or more accounts and which requires biometric authentication prior to enabling of the credit device for use.

### RELATED APPLICATIONS

This application claims the benefit of co-pending U.S. application Ser. No. 11/456,906, filed Jul. 12, 2006, entitled “Smartcard and Magnetic Stripe Emulator With Biometric Authentication”, U.S. provisional application Ser. No. 60/866,909, filed Nov. 22, 2006, entitled “Biometrically Secured Point Of Sale Transaction Device and U.S. provisional application Ser. No. 60/942,729, filed Jun. 8, 2007, entitled “Smartcard and Magnetic Stripe Emulator Having Biometric Authentication With Enhanced Features.”

### FIELD OF THE INVENTION

The present invention relates generally to the field of credit card transactions and, more specifically, to credit card transactions involving a device for performing point of sale transactions requiring biometric authentication prior to enabling of the device.

### BACKGROUND OF THE INVENTION

Credit cards in broad use in the marketplace today are typically one of two types. The first type is a “broadly-accepted” card which is useable at most merchants across the country. Examples of this type of card are the Visa®, Mastercard® and American Express® credit cards carried by millions worldwide and in common in use in the modern marketplace. This type of card also includes debit cards branded as a broadly-accepted credit card.

The second type of card is a “merchant-specific” card which is issued by a specific merchant and which may typically only be used at that specific merchant's place of business.

There is also a hybrid type card which is a broadly-accepted card which may be co-branded by both the card issuer and also by a specific merchant, which may be broadly used at other merchant's place of business.

There are currently several known methods of obtaining a credit card of either type and opening a credit card account. One method is to apply by filling out an application and submitting it to a credit card issuer via U.S. mail, online or over the phone. This typically requires several weeks between the time the application is made and when the credit card is provided to the user, typically by sending the card to the user via U.S. mail.

Another method is by applying for a credit card at a point-of-sale. The type of credit card applied for at the point of sale is typically a merchant-specific card or a hybrid card co-branded by the specific merchant, which may be applied for at the time purchase is being made at the merchant's place of business. The user's purchases that day are usually charged directly to the newly-opened account. Various incentives may be used to entice customers to open the credit card account, such as promotional items or attractive financing options for the purchases made that day.

Typically, for a point-of-sale application, the user would be required to fill out a credit application and the merchant is usually able to provide an approval by phone in a matter of minutes at a credit limit which will at least accommodate purchases being made at the time of application.

However, in this case, as with application made other than at a point-of-sale, the user is not provided with the physical card at the time of the approval of the account and the granting of credit. Instead, the user may be provided with a temporary paper credit voucher containing the user's account number, which may be used for purchases that day. Both the broadly-accepted card and the merchant-specific card applied for at a point-of-sale will usually be delivered to the user via US mail several weeks later.

One reason for the delay in between the time of application and the receipt of the card by the user is that individual credit cards must be custom embossed with the user's name, account number and a date of expiration of the card, and then magnetic stripe programmed with the user's account information to allow the use of the card at a point-of-sale terminal.

In light of the foregoing, there is a need which has been identified for an improved method for marketing and providing a credit card to a consumer.

### SUMMARY OF THE INVENTION

In response to the identified need, the present invention involves the issuance of the credit card or a credit card like device on site at the time of application by the user. For cards of the broadly-accepted type, application can be made at a bank or credit union, or at a kiosk-type establishment set up for that specific purpose. For merchant-specific cards, application can be made at a the specific merchant's place of business, typically at the point-of-sale (POS). The card or device is then issued to the user on the spot, eliminating the several week wait period until the permanent card arrives. The “permanent card”, for purposes of this application, shall mean the card which a typical user carries in his wallet or purse and which has a limited lifetime not to exceed the expiration date embossed on the card.

The present invention is centered around a device which is disclosed in co-pending U.S. application Ser. No. 11/546,906, which can be characterized as a combination smartcard and magnetic stripe card having a biometric authentication capability.

The user's account information may be read from the magnetic stripe on the device by swiping the device at a POS terminal. Alternatively, the user's account information may be transmitted via RF when queried by a contactless POS terminal. Both the information on the magnetic stripe, as well as the information in the device's memory which is transmitted via radio frequency (RF), may be disabled or changed on the fly by circuitry internal to the device. Information for several accounts are stored in non-volatile memory in the device, and may only be accessed after the proper biometric is entered into the device. After the account information has been read from the magnetic stripe or transmitted via the RF circuitry, the device is disabled, such that no account information may be obtained from the device until the user has re-authorized the use of the device using the built-in biometric scanner.

Performing a biometric authentication of the owner of the card is typically accomplished by scanning the user's fingerprint with a fingerprint sensor located on the device and comparing it with a previously-stored template of the user's fingerprint. Proper authentication causes the device to program one of several stored accounts into the magnetic stripe located on the rear of the card and/or enables the smartcard RF circuitry within the device such that the transaction can be accomplished at a POS terminal either by swiping the device through a magnetic card reader or by performing a contactless transfer of the account information via a contactless POS terminal.

The magnetic stripe and the smartcard circuitry are thereafter disabled such that account information cannot be obtained should the card become lost or stolen, without an additional biometric authentication. Alternatively, the device may be disabled after a predetermined period of time.

Such cards are able to be marketed differently than the typical credit card because they may be programmed on the fly with the account information specific to the user and do not require the embossing of the account number or the user's name on the exterior of the card. In fact, it is preferable with the device that the account number and the user's name not be embossed or otherwise appear on the exterior of the card, for security purposes.

Such cards may be distributed at any point of sale location by any merchant issuing a credit account to a customer. In addition, such cards may be issued on the fly at banks and credit unions in the form of a broadly-accepted credit card account and may also be marketed at stand-alone kiosks specific to the marketing of the credit account itself. The device can also be marketed as a stand-alone device without an accompanying newly-opened credit account, wherein the user may supply an already-existing credit account which may be programmed into the device.

Typically, cards which are sold and/or provided by merchants at point of sale locations may be branded with the merchant's trademark or other marketing information, while those provided at banks or credit unions may carry the bank's trademark as well as the trademark of Visa or Mastercard, if the accounts are of those types, or the card may be branded by the owner of a stand alone kiosk similar in the manner to which cellular phones are branded by individual cellular phone service providers.

The devices may be sold to consumers or may be provided as a courtesy by the merchants as an incentive for the user to open a credit account with the particular merchant. Once the user has obtained the device, additional accounts from other merchants and credit issuers may be programmed into the card, typically by logging on to the account issuer's website and downloading a “softcard” which contains the information necessary to allow the device to act as if it were a traditional credit card issued by the credit card issuer.

Thus, according to the present invention, the user is provided with a permanent credit device analogous to a permanent card, which may be utilized as a credit card for a plurality of accounts with any point-of-sale terminal using magnetic swipe or contactless methods of reading the account data from a credit card. The device is provided to the user immediately upon opening of the account at the point-of-sale. The device provided may be used to replace others of the user's credit cards such that the user only is required to carry around the single device instead of a multitude of credit cards.

### BRIEF DESCRIPTION OF THE DRAWINGS

FIG. 1 is a schematic diagram of the process by which the device is issued at a point of sale.

FIG. 2a is a flow chart showing the steps for approving a credit account and issuing the device at the point of sale.

FIG. 2b is a flow chart showing the steps for providing the device at a POS when a new credit account is not opened.

FIG. 3 is a schematic view of the front face of the permanent credit device described herein.

FIG. 4 is a schematic system view of the device and a base unit connected to a standard personal computer (PC).

### DETAILED DESCRIPTION OF THE INVENTION

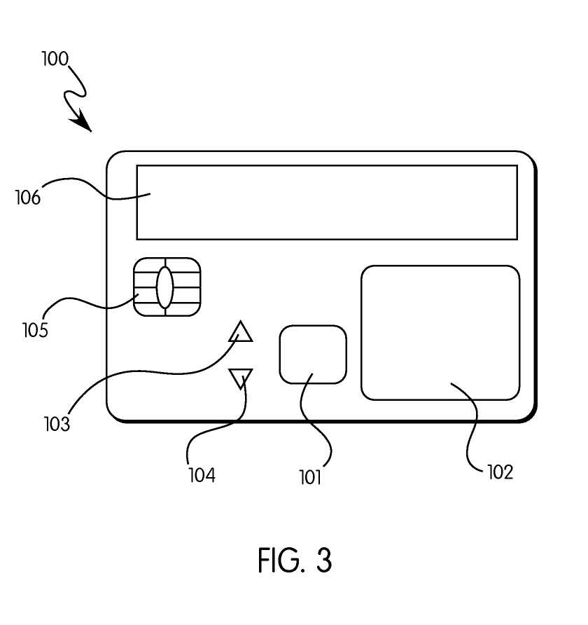

The methods described herein are designed to work with device 100 shown in FIG. 3. Device 100 can be characterized as a “permanent credit device” and is analogous to the “permanent credit card” that is issued to a user when a new account is opened.

Device 100 is a credit or debit card replacement having a biometric authorization component and the capability to store information from multiple accounts. Device 100 is credit card-sized and may have both magnetic stripe and RF capabilities, both of which may be enabled utilizing a biometric scanner, preferably a fingerprint scanner, to match a scanned biometric with a stored, previously obtained template.

Device 100 is shown in schematic form in FIG. 3. The face of the card includes biometric scanner 101, which, in the preferred embodiment, is a fingerprint scanner. Display 102 is preferably an LCD display which may be used to display various information regarding the accounts encoded within device 100, including account information, security codes and logos of the account issuers. Buttons 103 and 104 may be used to select between the various accounts stored on the card and may also be used to navigate menus for applications which may be stored on the card. Standard smartcard contacts 105 allow the exchange of data between device 100 and a PC, which allows the transfer of new account information to device 100 and the collection of information regarding usage of device 100. Smartcard contacts 105 also serve to recharge the internal battery of device 100.

Area 106 on the face of device 100 may be imprinted with the logo of the credit account issuer, for example, a broadly-accepted card such as Visa, MasterCard or American Express or the logo of a merchant for a merchant-specific card. The device has the dimensions of a standard credit card and may be used at any point of sale terminal utilizing a magnetic stripe reader or a contactless POS terminal wherein the account information is transferred via RF from device 100. Because no account information appears on the exterior of device 100, the account information stored on device 100 cannot be obtained therefrom prior to the authentication of the user via biometric scanner 101. Device 100 returns to its disabled state after the transmission of the account information via either the magnetic stripe or RF capabilities, or after a predetermined time period.

Alternative embodiments of device 100 are contemplated that are equipped with near field communication (NFC) capability that will allow the device 100 to act as an identification device, such as a driver's license or passport, and, in addition, to upload and download content, such as coupons or electronic tickets.

Device 100 is useful in the context of the inventive method described herein in that it can be issued to the user immediately at a POS without the delay typically experienced between the time the application for the account is submitted and the issuance of the card to the user. This delay is necessary with traditional credit cards to emboss the user's name, account number and expiration date on the card itself.

As previously stated, device 100 will preferably contain no embossed areas on the outer surface thereof. That is, the user's name and account information will not appear anywhere on the exterior of the card. The account information for newly opened accounts may be programmed into the device at the POS or may be downloaded through a communications network at the POS and transferred electronically to device 100.

Preferably, when the user leaves the POS, he will be able to carry newly issued device 100 with him and utilize it at the merchant's establishment. If the credit account applied for is of the broadly-accepted type, the user should be able to use device 100 at any location accepting a traditional credit card.

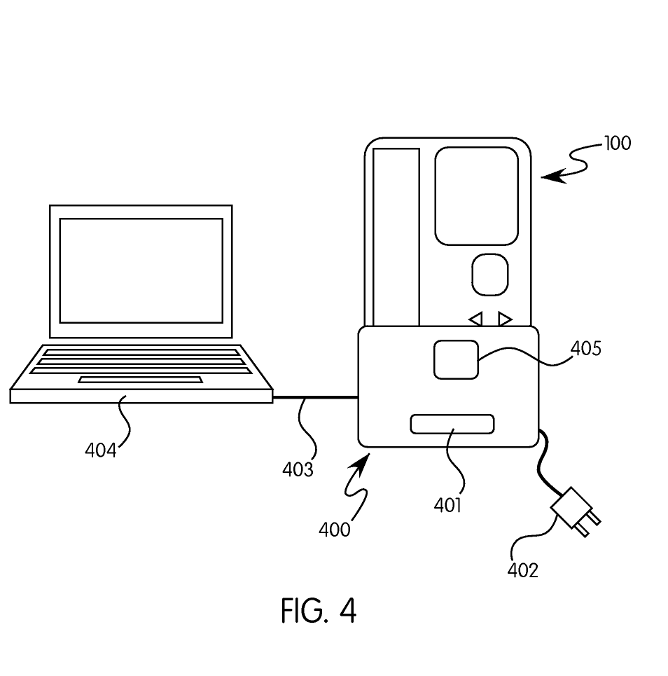

Also included with device 100 is base unit 400, show in FIG. 4, which allows device 100 to be connected to a PC, and for purposes of data exchange and the recharging of batteries within device 100. Base unit 400 is connected to PC 404 via cable 403. Base unit 400 may be powered by an AC adapter 402, or may be powered by one or more internal batteries 401.

Once the user has connected device 100 to PC 404 via base unit 400, an application, which may be a native software application installed on PC 404, or which may be accessed over the Internet via a standard web browser, allows information from others of the user's accounts to be downloaded in electronic form and stored in device 100. Preferably, PC 404 is connected to a communication network, such as the Internet, such that account information may be downloaded directly from the web sites of account issuers with which the user has previously set up account.

Preferably, device 100 will be capable of holding a plurality of accounts, limited only by the internal memory of the device. In use, when the user wishes to activate a particular account, the account would be selected via buttons 103 and/or 104 on the face of the card. The account name and/or logo is displayed on display 102 as the user scrolls through the list of available accounts and the particular account which is displayed when the biometric authentication is performed is the account that is enabled for one time or timed-out use by the user.

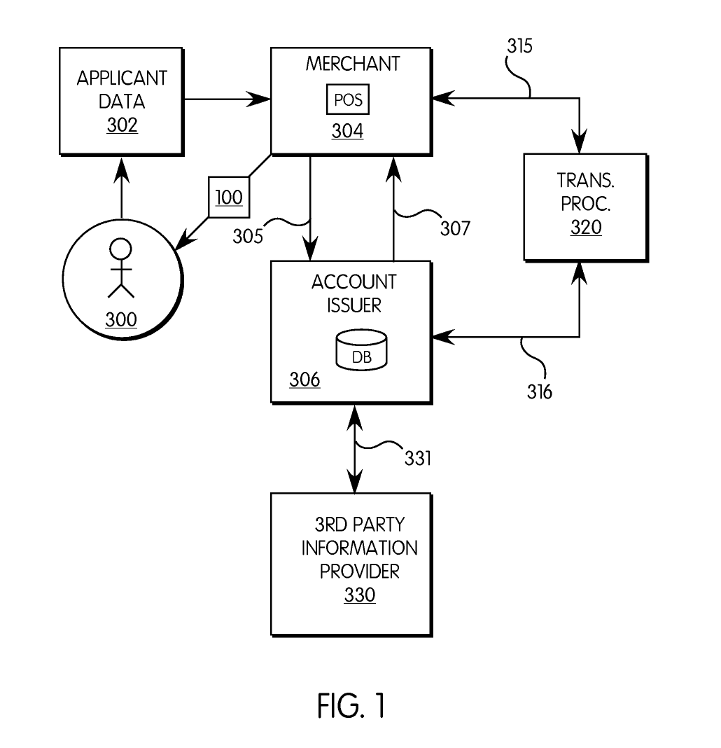

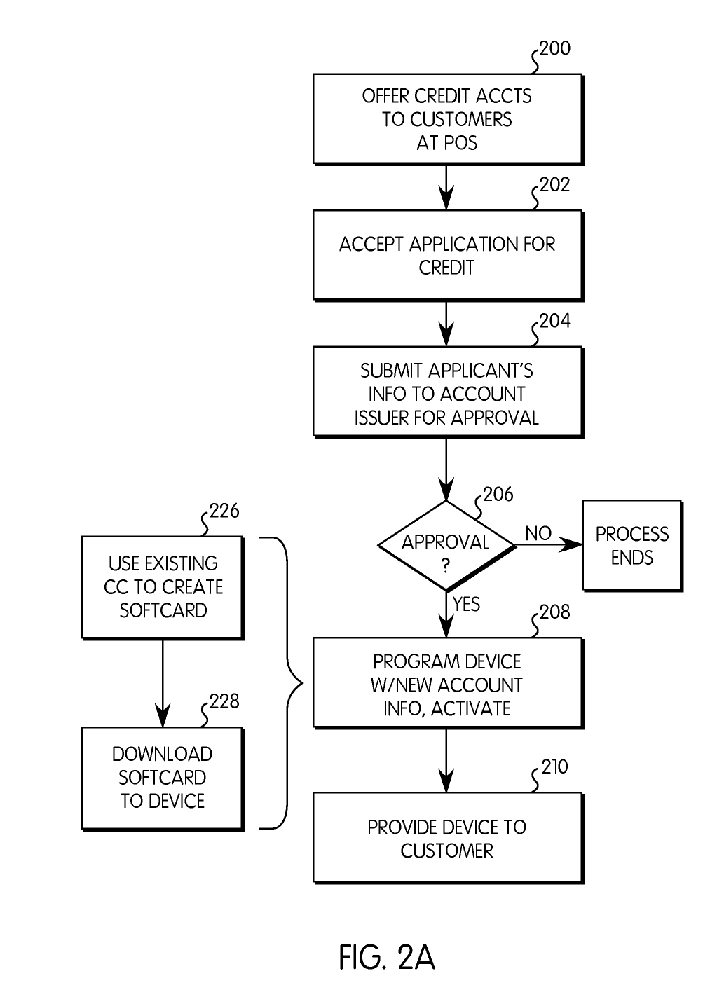

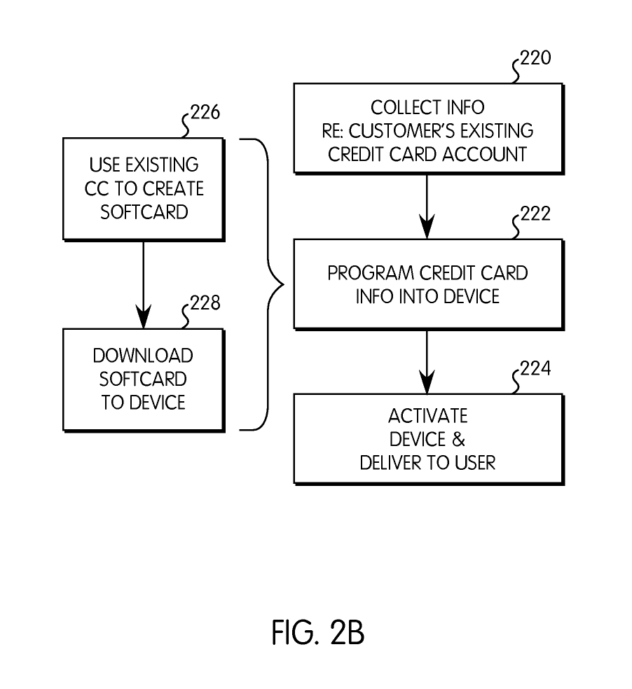

The process for issuing the card is shown schematically in FIG. 1 and in flowchart form in FIG. 2a. In box 200 in FIG. 2a, merchant 304 at the POS solicits customers 300 with offers to open a credit account. In box 202, the merchant accepts applicant data 302, which applicant 300 has supplied, preferably by filling out a form, entering it on-line or by providing the data orally to merchant 304. Merchant 304, in box 204, submits applicant data 302 to account issuer 306 for approval by any conventional means 305 such as, for example, via telephone, through the secured credit card network or via a broad based network such as the internet, preferably over a secured link. Alternatively, the merchant may approve the opening of the account without consulting a third party.

Account issuer 306 determines if applicant 300 is credit worthy and may obtain information regarding applicant 300 from a third party such 330, as a credit bureau. If account issuer 306 determines that applicant 300 is credit worthy, a credit account is established in the name of applicant 300 and approval is sent from account issuer 306 via channel 307 to merchant 304 at the POS. The approval occurs in box 206 of the flow chart of FIG. 2. Preferably, approval or disapproval of applicant 300 will occur within a matter on minutes while applicant 300 waits at the POS.

In box 208, merchant 304 at the POS sale may program device 100 with the new account information and provide device 100 directly to applicant 300. Device 100 may be programmed either by accepting the account information in electronic form, called a “softcard”, or the account information may be entered manually via a special management menu of device 100 accessible only to the issuer. Preferably, a softcard can be downloaded directly from the account issuer to eliminate errors in manually setting up device 100. Alternatively, device 100 may come pre-programmed with new account numbers which need only be activated.

In box 210, device 100 is activated and issued to user 300. Activation of the card will necessarily involve at least the collection of a sample of the user's biometric to be stored as a template within device 100, to be used as a control match each time the user wishes to enable the card. To collect the biometric, several samples are taken, and, in the case of a fingerprint, samples from different fingers should be taken. This guards against the situation in which a fingerprint is unable to be read from a certain finger, such as if the user has a cut in the fingerprint area of the finger. The biometric is preferably collected using biometric scanner 101 on device 100, for consistent results in the collection and matching of the biometric.

Merchant 304 at the POS may either issue a merchant-specific card branded with the merchant's logo and/or trademarks or may issue a broadly-accepted card which may be co-branded with a logo of the credit card company, such as Visa, MasterCard or American Express and the merchant.

Alternatively, the POS may consist of a kiosk type establishment provided for the sole purpose of issuing devices 100 containing newly opened broadly-accepted credit accounts. Such devices would likely be branded only by the broadly-accepted account issuer, such as Visa, MasterCard or American Express, and would be utilized in the same manner as a traditional broadly-accept card with the difference being that the user is able to obtain the card directly upon approval of the credit application 302 at the point of sale 304.

A device issued at a merchant's establishment is typically issued for the purpose of providing credit for purchases made by the user that day at the merchant's establishment. As such, device 100 may be supplied to the user as a courtesy of the merchant or the user may be charged a nominal amount for the device.

In an alternative method, shown in FIG. 2b, device 100 may be issued without opening a new credit account, but instead utilizing an account already held by the user. In box 220, merchant 304 collects information about an existing credit account from customer 300, preferably by having customer 300 present a traditional permanent credit card associated with the account to merchant 304. The merchant, in box 222, reads the account information and programs it into device 100. Alternatively, merchant 304 may read the account information directly from the customer's credit card using a POS terminal and use a special program to create a softcard based thereon which can be downloaded electronically to device 100. In box 224, device 100 is activated and delivered to customer 300.

Referring back again to FIG. 1, when user 300 utilizes device 100 at the merchant's POS 304, the user's account information is collected by the POS terminal just as if device 100 were a traditional credit card. The account information is then transmitted via communication channel 315 to a transaction processor 320. The transaction processor approves or disapproves of the use of the credit account and returns such approval or disapproval via communication shell 315 back to merchant 304. The account issuer 306 is then informed via channel 316 of the purchase and the user's account information and balance is updated. In addition, a credit is issued to merchant 304 via channel 307.

Thus the usage of device 100 as far as the merchant is concerned is the same as for a standard traditional credit card of any variety. Merchant 304 therefore needs no special equipment for the use of device 100 by user 300. Merchant 304 may use its currently existing POS equipment, be it either a magnetic stripe terminal with a magnetic stripe reader included therein or a terminal containing a RF interface which may query device 100 for contactless transfer of the account information to the POS terminal.

The methods disclosed herein are exemplary in nature and are not meant to limit the invention in any way. Substitutions or modifications may be made to the components illustrated in the drawings and described herein without departing from the spirit of the invention. The contemplated scope of the invention is therefore defined by the following claims.

We claim:

1. A method of issuing a credit account to an applicant at a point of sale comprising the steps of:
a. accepting a credit application at said point of sale location;
b. obtaining approval for the opening of a credit account, based on said credit application; and
c. issuing a permanent credit device to said applicant.

2. The method of claim 1 wherein said credit device is a traditional credit card.

3. The method of claim 1 wherein said credit device is programmable.

4. The method of claim 3 wherein said programmable credit device comprises:
a. a credit-card sized housing;
b. internal memory, for storing information regarding one or more accounts;
c. one or more communications interfaces, for transmitting said account information to said point of sale terminal; and
d. a biometric scanner, for enabling said credit device.

5. The method of claim 4 wherein further comprising the step of programming information for said credit account into said credit device before issuing said device to said applicant.

6. The method of claim 5 further comprising the step of activating said device.

7. The method of claim 6 wherein said activation step comprises at least the further step of collecting one or more biometric templates and storing said one or more biometric templates in said memory of said credit device.

8. The method of claim 5 wherein said credit account information is programmed into said device manually.

9. The method of claim 5 wherein said credit account information is downloaded electronically into said credit device.

10. The method of claim 9 wherein said credit account information is in the form of a softcard which is downloaded from the issuer of said credit account.

11. The method of claim 1 where in said credit device is branded with a name or logo of the issuer of said credit account.

12. The method of claim 4 further comprising the step of allowing said applicant to use said credit device for purchases at said point of sale.

13. The method of claim 4 wherein said communications interface comprises an interface selected from a group comprising a magnetic stripe and an RF interface.

14. The method of claim 4 wherein said credit device further comprises:
a. a display, for displaying account information; and
b. one or more buttons, for changing said account information displayed in said display.

15. The method of claim 4 wherein said device is compatible with conventional magnetic stripe scanners and contactless point of sale terminals.

16. The method of claim 5 further comprising the steps of:
a. collecting information from said user regarding other, existing credit accounts belonging to said user; and
b. programming said collected information into said credit device.

17. The method of claim 16 further comprising the steps of:
a. electronically reading the account information from an existing credit card belonging to said user; and
b. utilizing an application to create a softcard to be downloaded to said credit device.

18. A method of providing a permanent credit device to a user at a point of sale comprising the steps of:
a. collecting information from said user regarding an existing credit account belonging to said user;
b. programming said collected information into said credit device;
c. activating said credit device; and
d. issuing said credit device to said user.

19. The method of claim 18 wherein said programmable credit device comprises:
a. a credit-card sized housing;
b. internal memory, for storing information regarding one or more accounts;
c. one or more communications interfaces, for transmitting said account information to said point of sale terminal; and
d. a biometric scanner, for enabling said credit device.

20. The method of claim 19 wherein said activation step comprises at least the further step of collecting one or more biometric templates and storing said one or more biometric templates in said memory of said credit device.

21. The method of claim 18 wherein said credit account information is programmed into said credit device manually.

22. The method of claim 18 wherein said credit account information is downloaded electronically into said credit device.

23. The method of claim 22 further comprising the steps of:
a. electronically reading the account information from an existing credit card belonging to said user; and
b. utilizing an application to create a softcard to be downloaded to said credit device.

24. The method of claim 18 wherein said credit account information is in the form of a softcard which is downloaded from the issuer of said existing credit account.

25. The method of claim 18 where in said credit device is branded with a name or logo.

26. The method of claim 18 further comprising the step of allowing said applicant to use said credit device for purchases at said point of sale.

27. The method of claim 19 wherein said communications interface comprises an interface selected from a group comprising a magnetic stripe and an RF interface.

28. The method of claim 19 wherein said credit device further comprises:
a. a display, for displaying account information; and
b. one or more buttons, for changing said account information displayed in said display.

29. The method of claim 27 wherein said credit device is compatible with conventional magnetic stripe scanners and contactless point of sale terminals.
